(19) United States
(12) Patent Application Publication
(10) Pub. No.: US 2023/0037446 A1
(43) Pub. Date: Feb. 9, 2023

(54) RECYCLABLE MULTILAYER FILMS AND METHODS OF MAKING SAME

(71) Applicant: Colormasters, LLC, Albertville, AL (US)

(72) Inventors: Robert E. Chambliss, Trussville, AL (US); James Harvey, Guntersville, AL (US); Tyler Floyd, Boaz, AL (US)

(73) Assignee: Colormasters, LLC, Albertville, AL (US)

(21) Appl. No.: 17/861,308

(22) Filed: Jul. 11, 2022

Related U.S. Application Data
(60) Provisional application No. 63/221,549, filed on Jul. 14, 2021.

(51) Int. Cl. B32B 27/32; B32B 27/20; B32B 7/10; B32B 27/08

(52) U.S. Cl. CPC B32B 27/32; B32B 27/20; B32B 7/10; B32B 27/08; B32B 2250/03; B32B 2307/306; B32B 2307/72; B32B 2270/00; B32B 2553/00; B32B 2250/242; B32B 2264/02; B32B 2250/40

(57) ABSTRACT

Recyclable films and methods of making the recyclable films are provided. The recyclable films include a low melt index blend of super hexene LLDPE and bimodal HDPE and an anti-stick additive having a melting point of at least about 115° C. The recyclable films have a heat resistant coating on the film surface that prevents the film from softening and sticking to heat seal jaws during the production process. The recyclable films also have improved tear strength and melt strength such that instances of tears or break offs during the machine direction orientation portion of the production process are significantly reduced or eliminated.

### CROSS-REFERENCE TO RELATED APPLICATIONS

This application claims the benefit of and priority to U.S. Provisional Application No. 63/221,549 filed on Jul. 14, 2021, and entitled “Recyclable Multilayer Films and Methods of Making Same,” the disclosure of which is expressly incorporated by reference in its entirety.

### TECHNICAL FIELD

The present disclosure relates generally to recyclable thermoplastic films, and specifically to a heat resistant, anti-stick agent and an engineered two-factorial component blend for use therewith.

### BACKGROUND

Regulatory and public concerns regarding sustainability have driven the packaging industry to move to recyclable materials. This has caused the packaging industry to move away from the use of biaxially oriented polyester (BOPET) in many packaging applications, such as stand-up pouches and wet wipes pouches, due its non-recyclability into common consumer waste streams made up of polyethylene (PE). However, there are challenges in finding a HDPE replacement for BOPET that has acceptable levels of stiffness, optical clarity, barrier properties, and heat resistance.

The machines for manufacturing packaging applications, such as stand-up pouches and wet wipes pouches, were originally designed to use a BOPET lamination. In this case, the heat seal jaws contact the outer surface of BOPET and drive heat inward towards the low temperature melt point sealant. The sealant is then melted and fused together, while the BOPET substrate remains rigid and un-softened. The heat resistance of BOPET is high enough to prevent softening or sticking of the seal jaws. When manufacturers started producing HDPE replacement films, the manufacturers turned to machine-direction orientation (MDO) processes. The MDO process adds stiffness, moisture and oxygen barrier properties, and improves the optical clarity of the HDPE, which is not clear on its own. Similar to a BOPET substrate, the MDO HDPE is laminated to a sealant web made up of low temperature polymers. Film producers have generally relied on the MDO process to provide the necessary heat resistance and rigidity to work on the packaging machines designed for BOPET. With HDPE-based substrates, however, the MDO process does not sufficiently modify the HDPE, which leads to failures due to the substrate softening and sticking to the heat seal jaws on the machines and packaging lines.

Moreover, conventional films have a tendency to break from stretching or tear from heating during the MDO process because of reduced melt strength. When a break-off or hole occurs during the MDO process, the damaged film must be manually cleared from the line and the process generally must be restarted. This can cause significant production waste and downtime while the broken film is cleared, and the process is restarted. To counteract this, workers may be positioned at various points on the production line to react in case the film breaks off, tears, loses trim or otherwise. This requires devotion of significant human resources to the film making process.

Accordingly, there remains a need in the art for improved PET replacement films that are recyclable and provide excellent mechanical properties and heat resistance. Improved techniques for producing the replacement films are also generally desirable.

### SUMMARY

The problems expounded above, as well as others, are addressed by the following inventions, although it is to be understood that not every embodiment of the inventions described herein will address each of the problems described above.

In some embodiments, a recyclable film having at least one layer is provided, the layer including a blend of a first thermoplastic polymer and a second thermoplastic polymer, wherein each of the first thermoplastic polymer and the second thermoplastic polymer has a melt index of about 0.5 g/10 min. or less, and an anti-stick additive including an amide compound having a melting point of at least about 115° C. In one embodiment, the first thermoplastic polymer and the second thermoplastic polymer are each selected from the group consisting of linear low-density polyethylene (LLDPE), super hexene linear low-density polyethylene (super hexene LLDPE), bimodal metallocene linear low-density polyethylene (mLLDPE), low-density polyethylene (LDPE), high-density polyethylene (HDPE), bimodal high-density polyethylene (bimodal HDPE), and combinations of the foregoing. In another embodiment, the first thermoplastic polymer is linear low-density polyethylene (LLDPE), super hexene linear low-density polyethylene (super hexene LLDPE), bimodal metallocene linear low-density polyethylene (mLLDPE), or a combination of the foregoing. The first thermoplastic polymer may have a melt index of about 0.5 g/10 min. In further embodiments, the second thermoplastic polymer is high-density polyethylene (HDPE), bimodal high-density polyethylene (bimodal HDPE), or a combination of the foregoing. The second thermoplastic polymer may have a melt index of about 0.45 g/10 min. In still other embodiments, the first thermoplastic polymer and the second thermoplastic polymer are present in the blend in a ratio of about 50:50. In one embodiment, the anti-stick additive is a bisamide. For example, the anti-stick additive may be ethylene bis(oleamide). In further embodiments, the anti-stick additive is present in the layer in an amount of about 3% by weight or less.

In other embodiments, a recyclable multi-layer film is provided, the recyclable multi-layer film including an outer layer, an inner layer, and an intermediate layer disposed between the outer layer and the inner layer, wherein the intermediate layer includes a blend of a first thermoplastic polymer selected from the group consisting of LLDPE, super hexene LLDPE, mLLDPE, and combinations thereof, and a second thermoplastic polymer selected from the group consisting of HDPE, bimodal HDPE, and combinations thereof, wherein each of the first thermoplastic polymer and the second thermoplastic polymer has a melt index of about 0.5 g/10 min. or less, and wherein the outer layer, the inner layer, and the intermediate layer each include an anti-stick additive, wherein the anti-stick additive includes a bisamide having a melting point of at least about 115° C.

In one embodiment, the anti-stick additive may be present in each of the outer layer, the inner layer, and the intermediate layer in an amount of about 4% by weight or less. In further embodiments, the anti-stick additive is ethylene bis(oleamide). In still further embodiments, the anti-stick additive has a melting point of at least about 125° C. In yet further embodiments, the first thermoplastic polymer is super hexene LLDPE and the second thermoplastic polymer is bimodal HDPE.

In still other embodiments, a packaging container formed of a recyclable multi-layer film is provided, the recyclable multi-layer film including at least one layer including a blend of a first thermoplastic polymer selected from the group consisting of LLDPE, super hexene LLDPE, mLLDPE, or a combination of the foregoing, and a second thermoplastic polymer selected from the group consisting of HDPE, bimodal HDPE, or a combination of the foregoing, wherein each of the first thermoplastic polymer and the second thermoplastic polymer has a melt index of about 0.5 g/10 min. or less, and an anti-stick additive, wherein the anti-stick additive includes a bisamide having a melting point of at least about 120° C.

In some embodiments, the bisamide may be ethylene bis(oleamide). In further embodiments, the anti-stick additive is present in the layer in an amount of about 3% by weight or less. In still further embodiments, the first thermoplastic polymer is super hexene LLDPE and the second thermoplastic polymer is bimodal HDPE. In yet further embodiments, the packaging container has a water vapor transmission rate of less than about 0.250 g/100 in²/day.

### BRIEF DESCRIPTION OF THE DRAWINGS

Further features and advantages can be ascertained from the following detailed description that is provided in connection with the drawings described below:

FIG. 1 shows an exemplary film in accordance with an embodiment of the present disclosure.

FIG. 2 shows an exemplary process for producing the film illustrated in FIG. 1 in accordance with an embodiment of the present disclosure.

### DETAILED DESCRIPTION

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural forms as well, unless the context clearly indicates otherwise.

The terms “first”, “second”, and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Terms such as “at least one of A and B” should be understood to mean “only A, only B, or both A and B.” The same construction should be applied to longer list (e.g., “at least one of A, B, and C”).

In some places reference is made to standard methods, such as but not limited to methods of measurement. It is to be understood that such standards are revised from time to time, and unless explicitly stated otherwise reference to such standard in this disclosure must be interpreted to refer to the most recent published standard as of the time of filing.

“Outer surface” or “outer layer” as used herein refers to the portion of a film that is located outermost of all the surfaces or layers respectively of the film.

“Inner layer” as used herein refers to a layer that is not exposed to handling and the environment. Inner layers may provide functionality as needed for particular applications and may provide barrier protection and/or structural strength.

“Melt Index (MI)” may refer to a measure of the ease of flow of the melt of a thermoplastic polymer. Melt index may be measured in grams flowing per ten-minute time interval (g/10 min.) according to methods described in relevant editions of ASTM D1238, approved August 2013 and ISO 1133 published December 2011 and revised February 2012.

### Recyclable Films

The present disclosure provides recyclable thermoplastic films that are suitable replacements for polyethylene terephthalate (PET) films. The recyclable films of the present disclosure include the use of an anti-stick additive that creates a heat resistant coating on the film surface and prevents the film from softening and sticking to the heat seal jaws during the production process. The recyclable films may also include an ultra-low melt index two component blend that provides improved tear strength and melt strength such that instances of tears or break offs during the machine direction orientation portion of the production process are significantly reduced or eliminated.

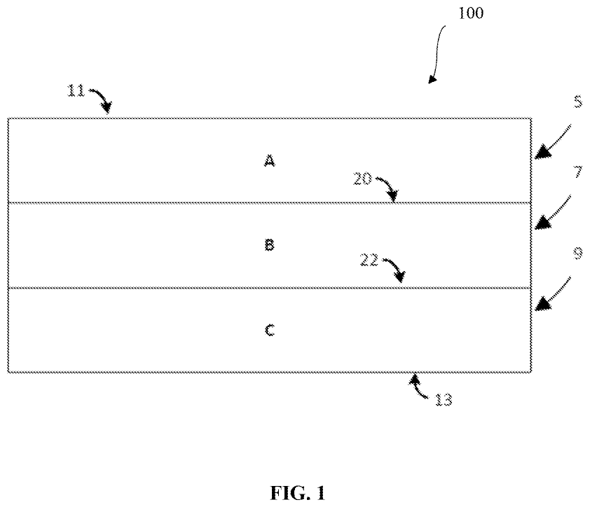

FIG. 1 shows a film 100 in accordance with an exemplary embodiment of the present disclosure. The film 100 illustrated in FIG. 1 has three layers 5, 7, and 9, each including an anti-stick additive, thermoplastic blend, or combination thereof, as will be discussed in more detail below. Although the film 100 of FIG. 1 is shown with three layers, in some embodiments, the film 100 may include as few as one layer (e.g. monolayer), two layers, or more than three layers. For example, the film 100 may include up to approximately 10 layers, or other numbers of layers. The film 100 has two outer surfaces 11, 13 which may be outermost surfaces of layer 5 and layer 9, respectively. As shown in FIG. 1, in some embodiments, the layer 5 may be arranged on or adjacent to layer 7, and layer 7 may be arranged on or adjacent to layer 9. Each of layer 5 and layer 7 may be outer “skin” layers of the film 100, while layer 9 may be a core layer of the film 100. Other arrangements are possible in other embodiments.

The layers of the film 100 may be formed from a variety of thermoplastic polymers including, but not limited to, polyolefins, for example, polyethylene, such as those of low, medium or high density, polypropylene, functionalized polyolefins, polyesters, poly(ester-ether), polyamides, including nylons, poly(ether-amide), polyether sulfones, fluoropolymers, polyurethanes, and combinations thereof. The polyethylene may be substantially linear or branched, and may be formed by various processes known in the art using catalysts such as Ziegler-Natta catalysts, metallocene or single-site catalysts or others widely known in the art. For example, in some embodiments, each of the outermost layer (for example, layer 5) and the innermost layer (for example, layer 9) may be formed of high-density polyethylene.

In some embodiments, one or more layers of the film 100 (for example, layers 5, 7, or 9) may include a blend of two or more thermoplastic polymers having a low melt index. For example, an intermediate layer (for instance, layer 7) may include the blend of two or more thermoplastic polymers having a low melt index. Without being bound by any particular theory, it is believed that by lowering the melt index of a thermoplastic polymer, the viscosity and entanglement of the polymer chains may be increased, which results in films having increased tensile strength and melt strength. Indeed, the blends disclosed herein provide a synergistic multiplier effect in mechanical properties, such as tensile strength, that is at least four times greater than the sum of the two or more components alone. In other embodiments, the blends disclosed herein provide a synergistic multiplier effect in tensile strength that is at least five times greater than the sum of the two or more components alone.

In one embodiment, the blend may include linear low-density polyethylene (LLDPE). As used herein, LLDPE refers to linear copolymers of ethylene and an α-olefin, such as butene, hexene, or octene. The LLDPE may be super hexene linear low-density polyethylene (super hexene LLDPE), such as Westlake HIFOR® Xtreme including one or more of grades SC74858, SC74844, and SC74853; bimodal metallocene linear low-density polyethylene (mLLDPE), such as Exxon Enable™; or various combinations thereof. For example, in one embodiment, the LLDPE is super hexene LLDPE. The LLDPE present in one or more layers of the film 100 may have a melt index of about 0.7 g/10 min or below. In another embodiment, the LLDPE present in one or more layers of the film 100 may have a melt index of about 0.5 g/10 min. or below. In still another embodiment, the LLDPE present in one or more layers of the film 100 may have a melt index of about 0.4 g/10 min. or below. In yet another embodiment, the LLDPE present in one or more layers of the film 100 may have a melt index of about 0.3 g/10 min. or below. In a preferred embodiment, the LLDPE has a melt index of about 0.5 g/10 min. The LLDPE present in one or more layers of the film 100 may have a tensile strength at break of about 60 MPa; alternatively, about 50 MPa to about 60 MPa.

In another embodiment, the blend may include high-density polyethylene (HDPE). As used herein, HDPE refers to homopolymers and copolymers of ethylene and an α-olefin (usually 1-butene or 1-hexene) having densities between 0.93 and 0.97 g/cm³. In some embodiments, the blend may include bimodal HDPE. By the term, “bimodal,” it is meant that the polymer comprises at least two components, one of which has a relatively low molecular weight and a relatively high density and another of which has a relatively high molecular weight and a relatively low density. The HDPE present in one or more layers of the film 100 may have a melt index of about 0.7 g/10 min or below. In another embodiment, the HDPE present in one or more layers of the film 100 may have a melt index of about 0.5 g/10 min. or below. In still another embodiment, the HDPE present in one or more layers of the film 100 may have a melt index of about 0.4 g/10 min. or below. In yet another embodiment, the HDPE present in one or more layers of the film 100 may have a melt index of about 0.3 g/10 min. or below. In a preferred embodiment, the HDPE has a melt index of about 0.45 g/10 min. The HDPE present in one or more layers of the film 100 may have a tensile strength at break of about 35 MPa. In other embodiments, the HDPE present in one or more layers of the film 100 may have a tensile strength at break of about 25 MPa to about 45 MPa.

In some embodiments, any of the aforementioned thermoplastic polymers may be present in the film 100 or in individual layers with respect to another of the aforementioned thermoplastic polymers in a ratio of about 50% to about 50% (for example, 1:1). In another embodiment, any of the aforementioned thermoplastic polymers may be present in the film 100 or in individual layers with respect to another of the aforementioned thermoplastic polymers in a ratio of about 45% to about 55%. As an example, in an exemplary embodiment, a ratio of LLDPE, such as super hexene LLDPE, to HDPE, such as bimodal HDPE, may be about 50% to 50%.

In other embodiments, the aforementioned thermoplastic polymers may be present in the film 100 or in individual layers (for example, layers 5, 7, or 9) in an amount varying from about 1% to 97% by weight. In another embodiment, the aforementioned thermoplastic polymers may be present in the film 100 or in individual layers (for example, layers 5, 7, or 9) in an amount varying from about 10% to about 80% by weight. In still another embodiment, the aforementioned thermoplastic polymers may be present in the film 100 or in individual layers (for example, layers 5, 7, or 9) in an amount varying from about 20% to about 70% by weight. In yet another embodiment, the aforementioned thermoplastic polymers may be present in the film 100 or in individual layers (for example, layers 5, 7, or 9) in an amount varying from about 30% to about 60% by weight. For example, the aforementioned thermoplastic polymers may be present in the film 100 or in individual layers (for example, layers 5, 7, or 9) in an amount of about 50% by weight.

In some embodiments, one or more layers of the film 100 (for example, layers 5, 7, or 9) include an anti-stick additive. As used herein, an “anti-stick additive” may refer to one or more heat-resistant substances or compounds used to prevent the film from softening and sticking to the heat seal jaws during the production process. Without being bound by any particular theory, it is believed that the anti-stick additive migrates to and blooms out onto the outer surface of the film and creates a heat-resistant coating on the surface of the film 100. The heat-resistance provided by the anti-stick additive prevents the film from sticking to the heat seal jaws.

In one embodiment, the anti-stick additive is a bisamide. “Bisamide,” as used herein, refers to any compound containing two amide groups. For example, the anti-stick additive may be ethylene bis(oleamide). The films of the present disclosure may include a compound having the structure of formula (I):

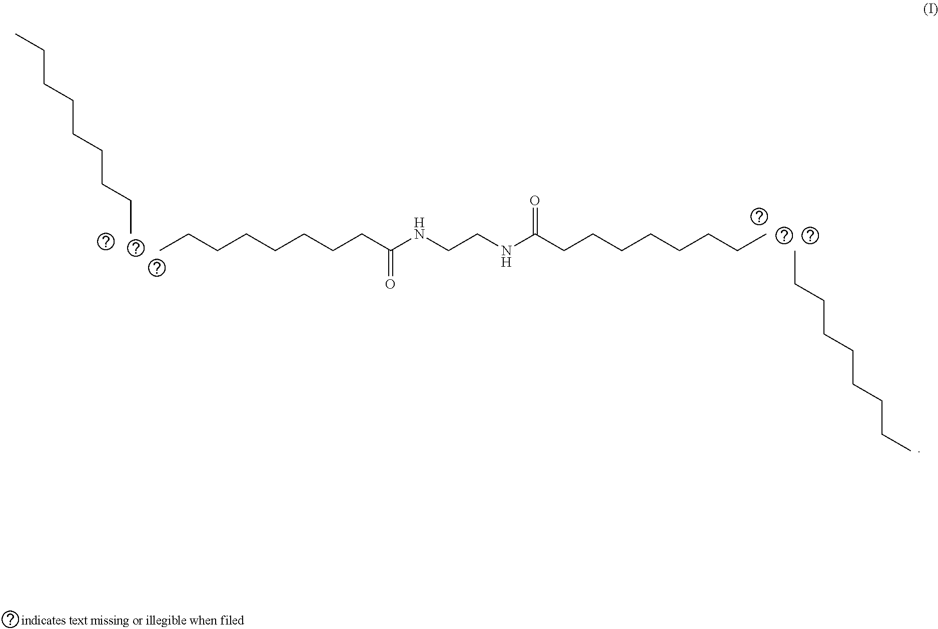

Examples of commercially available anti-stick additives contemplated by the present disclosure include Slip Additive 102109 by Ampacet Corporation and Crodamide™ EBO by Croda International.

In some embodiments, the anti-stick additive has a melting point of about 115° C. or higher. In another embodiment, the anti-stick additive has a melting point of about 120° C. or higher. In still another embodiment, the anti-stick additive has a melting point of about 125° C. or higher. In yet other embodiments, the anti-stick additive has a melting point of about 130° C. or higher. In further embodiments, the anti-stick additive is optically clear. In this embodiment, the anti-stick additive has a light transmission of at least 85% over the range of from 380 to 780 nm. In other embodiments, the anti-stick additive has a light transmission of at least 90% over the range of from 380 to 780 nm.

The anti-stick additive may be present in one or more layers of the film 100. In one embodiment, the anti-stick additive is present in at least two layers of the film 100. In another embodiment, the anti-stick additive is present in at least three layers of the film 100. For example, in a preferred three-layer film embodiment, the anti-stick additive is present in each layer of the film 100. In some embodiments, the anti-stick additive is present in the one or more layers of the film 100 with the thermoplastic blend described above. In other embodiments, the anti-stick additive is present in the one or more layers of the film 100 without the thermoplastic blend.

In some embodiments, the anti-stick additive is present in the one or more layers of the film 100 in an amount of about 4% by weight or less. In another embodiment, the anti-stick additive is present in the one or more layers of the film 100 in an amount of about 3% by weight or less. In still another embodiment, the anti-stick additive is present in the one or more layers of the film 100 in an amount of about 2% by weight of less. In yet other embodiments, the anti-stick additive is present in the one or more layers of the film 100 in an amount of about 1% by weight or less. For example, the anti-stick additive may be present in the one or more layers of the film 100 in an amount of about 2% by weight. In further embodiments, the anti-stick additive may be present in the one or more layers of the film 100 in an amount of about 3% to 4% by weight.

The one or more layers of the film 100 may also include various optional additives. Preferred additives include color concentrates, colorization components, pigments, dyes, antioxidants, slip agents, foaming agents, neutralizers, processing aids, lubricants, heat or light stabilizers, UV stabilizers, hydrocarbon resins, antistatics, fillers, plasticizers, compatibilizers, draw down polymers, viscosity-reducing polymers, and anti-blocking agents. A color concentrate may be added to yield a colored layer, an opaque layer, or a translucent layer. Preferred color concentrates include color formulations, including black, white, and other colors suitable for the film of the present invention.

The optional additives may be present in the one or more layers of the film 100 in an amount of about 0.10% to about 50% by weight. In one embodiment, the optional additives are present in the one or more layers of the film 100 in an amount of about 0.20% to about 45% by weight. In another embodiment, the optional additives are present in the one or more layers of the film 100 in an amount of about 0.50% to about 35% by weight. In still another embodiment, the optional additives are present in the one or more layers of the film 100 in an amount of about 1% to about 25% by weight. In yet another embodiment, the optional additives are present in the one or more layers of the film 100 in an amount of about 2% to about 10% by weight. For example, the optional additives may be present in the one or more layers of the film 100 in an amount of about 0.50% to about 2% by weight.

Typically, the thickness of the film 100 is referenced in terms of MILs or gauge (GA, wherein 10GA=0.1 MIL). In one embodiment, the thickness of the film 100 can be from about 0.5 MIL to 1.5 MIL. In another embodiment, the thickness of the film 100 may range from about 0.7 MIL to 1.4 MIL. In still another embodiment, the thickness of the film 100 may range from about 0.7 MIL to 1.3 MIL. In yet another embodiment, the thickness of the film 100 may range from about 0.8 MIL to 1.25 MIL. In still other embodiments, the thickness of the film 100 may range from about 1 MIL to 1.2 MIL.

In one embodiment, an outer layer of the film 100 (for example, layers 5 and 9) may have a thickness ranging from about 0.15 MIL to about 0.40 MIL. In another embodiment, the outer layers of the film 100 (for example, layers 5 and 9) may have a thickness ranging from about 0.20 MIL to about 0.35 MIL. In still another embodiment, the outer layers of the film 100 (for example, layers 5 and 9) may have a thickness ranging from about 0.25 MIL to about 0.30 MIL.

In further embodiments, an inner layer of the film 100 (for example, layer 7) may have a thickness ranging from about 0.40 MIL to about 0.70 MIL. In another embodiment, the inner layer of the film 100 (for example, layer 7) may have a thickness ranging from about 0.45 MIL to about 0.65 MIL. In still other embodiments, the inner layer of the film 100 (for example, layer 7) may have a thickness ranging from about 0.50 MIL to about 0.60 MIL.

The thicknesses disclosed herein advantageously allow for reverse printing on the films of the present disclosure. Due to the thinness of the layers, printing may occur on the inside of the outermost layer such that any ink printing is protected from the outside environment. Reverse printing helps prevent scuffing or scraping of the ink. Any known methods for reverse printing may be utilized in accordance with the present invention. For example, printing can be done by any known means using commercially available UV, Flexographic, UV Flexographic, water-based, solvent or other inks which result in complete adhesion of ink to the label surface. Generally, reverse printing involves having the film layer to be reverse printed undergo treatment so that the film layer will accept ink. The film layer may undergo any suitable surface treatment including, but not limited to, corona discharge treatment, plasma treatment, UV treatment, and/or electron beam treatment. The surface treatment helps make the film layer porous, which allows for the film layer to accept ink more readily. Then, a negative of the design to be printed may be laminated onto the layer such that the printing occurs on the inside of the layer (or the reverse side of the label face). This process may be repeated for any layer of the film that will display a label or design.

The one or more layers of the film 100 may have varying basis weights. In one embodiment, an outer layer of the film 100 (for example, layers 5 and 9) may have a basis weight that is about 5% to about 30% of a total basis weight of the film 100. In some embodiments, the outer layer of the film 100 (for example, layers 5 and 9) may have a basis weight that is about 10% to about 25% of a total basis weight of the film 100. For example, the outer layer of the film 100 (for example, layers 5 and 9) may have a basis weight that is about 25% of a total basis weight of the film 100. In further embodiments, an inner layer of the film 100 (for example, layer 7) may have a basis weight that is about 40% to about 80% of a total basis weight of the film 100. In some embodiments, the inner layer (for example, layer 7) may have a basis weight that is about 45% to about 70% of a total basis weight of the film 100. In other embodiments, the inner layer (for example, layer 7) may have a basis weight that is about 50% to about 60% of a total basis weight of the film 100. For instance, the inner layer (for example, layer 7) may have a basis weight that is about 50% of a total basis weight of the film 100.

In some embodiments, each of the outermost layers of film 100 (e.g., “skin” layers 5 and 9) may have approximately the same basis weight. As an example, in some embodiments, layer 5 may have a basis weight of about 25% of a total basis weight of the film 100; layer 7 may have a basis weight of about 50% of a total basis weight of the film 100; and layer 9 may have a basis weight of about 25% of a total basis weight of the film 100.

In addition, the film 100 has two interfaces, 20 and 22. The interfaces may generally correspond to a boundary between adjacent layers. Interface 20 may correspond to a boundary of layer 5 and layer 7, and interface 22 may correspond to a boundary of layer 7 and 9. A number of interfaces of the film 100 may affect aspects of the film 100, such as tear strength and optical performance (e.g., clarity, haze, gloss, etc.). As a result, although the film may have various numbers of interfaces based on a number of layers, in some preferred embodiments, the film 100 includes two interfaces 20 and 22.

The film 100 of FIG. 1 is shown as having a particular length, but a film according to some embodiments of the present disclosure may be produced to have various desired lengths. As described further below, the components of film 100 may be heated, extruded, and blown to form a film sheath, bubble or similar structure. Length of the film 100 may be related to an amount of resin or material that is extruded and blown; accordingly, length of film 100 may be based on an amount (e.g., volume) of constituent film components (e.g., resins) which are melted, extruded and blown to form film 100.

In some embodiments, the films 100 of the present disclosure are recyclable and serve as suitable replacements for films made of PET. Upon disposal of the film made in accordance with the present disclosure (or subsequent product formed of the film), the film and/or product may be recycled. Indeed, the film of the present disclosure can be recyclable to the same extent that #2 HDPE film or #4 linear low-density polyethylene (LLDPE) film is recyclable.

The films formed in accordance with the present disclosure also show superior physical and mechanical properties. For example, the films of the present disclosure have reduced melt strengths when compared to conventional polyethylene films. In one embodiment, the film 100 may have a melt index of about 0.5 g/10 min. or less. In some embodiments, the film 100 may have a melt index of about 0.1 g/10 min. to about 0.5 g/10 min. In still other embodiments, the film 100 may have a melt index of about 0.3 g/10 min. to about 0.5 g/10 min.

The films of the present disclosure also demonstrate superior tensile strength. As used herein, “tensile strength” refers to the amount of stress a material can handle before reaching permanent, non-elastic deformation as measured in accordance with ASTM D882. The film 100 according to some embodiments of the present disclosure may have a tensile strength (MD—machine direction) of about 17,500 lbf/in² to about 20,000 lbf/in². In another embodiment, the film 100 of the present disclosure may have a tensile strength of about 18,000 lbf/in² to about 19,500 lbf/in². In still other embodiments, the film 100 of the present disclosure may have a tensile strength of about 18,500 lbf/in² to about 19.000 lbf/in². The film 100 according to some embodiments of the present disclosure may have a tensile strength (TD—transverse direction) of about 3,000 lbf/in² to about 4,500 lbf/in². In another embodiment, the film 100 may have a tensile strength of about 3,500 lbf/in² to about 4,000 lbf/in².

The films of the present disclosure further demonstrate superior elongation values. “Elongation at yield,” as used herein, is the strain that the material undergoes at the yield point, or the percent change in length that occurs while the material is stressed to its yield point as measured in accordance with ASTM D882. In one embodiment, the films may have an elongation at yield (MD—machine direction) of about 95 percent to about 200 percent. In another embodiment, the films may have an elongation at yield (MD—machine direction) of about 100 percent to about 195 percent. In still another embodiment, the films may have an elongation at yield (MD—machine direction) of about 110 percent to about 175 percent. In yet another embodiment, the films may have an elongation at yield (MD—machine direction) of about 160 percent.

The films of the present disclosure also have superior Elmendorf tear strength. In one embodiment, the films have an Elmendorf tear strength in the machine direction of equal to or greater than about 20 g as determined in accordance with ASTM D1922. In another embodiment, the films have an Elmendorf tear strength in the machine direction of equal to or greater than about 25 g as determined in accordance with ASTM D1922. In still another embodiment, the films have an Elmendorf tear strength in the machine direction of equal to or greater than about 30 g as determined in accordance with ASTM D1922. In further embodiments, the films have an Elmendorf tear strength in the transverse direction of equal to or greater than about 700 g as determined in accordance with ASTM D1922. In another embodiment, the films have an Elmendorf tear strength in the transverse direction of equal to or greater than about 750 g as determined in accordance with ASTM D1922. In still another embodiment, the films have an Elmendorf tear strength in the transverse direction of equal to or greater than about 790 g as determined in accordance with ASTM D1922.

In further embodiments, the films of the present disclosure have superior oxygen and moisture barrier properties, such as superior water vapor transmission rates and oxygen transmission rates. “Water Vapor Transmission” specifies the amount of water vapor in grams transferred through a 100 in.² area of the film in a 24-hour period. In one embodiment, the films of the present disclosure have a water vapor transmission rate of less than about 0.300 g/100 in²/day. In another embodiment, the films of the present disclosure have a water vapor transmission rate of less than about 0.250 g/100 in²/day. In still another embodiment, the films of the present disclosure have a water vapor transmission rate of less than about 0.225 g/100 in²/day. In yet another embodiment, the films of the present disclosure have a water vapor transmission rate of less than about 0.210 g/100 in²/day. “Oxygen Transmission Rate” is the steady state rate at which oxygen gas permeates through the film. In one embodiment, the films of the present disclosure have an oxygen vapor transmission rate of less than about 8 cc/100 in²/day. In another embodiment, the films of the present disclosure have an oxygen vapor transmission rate of less than about 7.75 cc/100 in²/day. In still another embodiment, the films of the present disclosure have an oxygen vapor transmission rate of less than about 7.5 cc/100 in²/day. In yet another embodiment, the films of the present disclosure have an oxygen vapor transmission rate of less than about 7 cc/100 in²/day.

The films of the present disclosure also demonstrated superior clarity. In one embodiment, the films of the present disclosure may have a clarity of at least 95%. In another embodiment, the films of the present disclosure may have a clarity of at least 97%. In still another embodiment, the films of the present disclosure may have a clarity of at least 99%. In yet other embodiments, the films of the present disclosure may have a clarity of at least 99.5%.

The films described herein are useful for a variety of purposes, including, for example, use in packaging containers. In some embodiments, the films described herein are suitable replacements for PET films in applications, such as packaging containers. In other embodiments, the films described herein are useful for packaging applications, such as stand-up pouches and wet wipes pouches.

### Methods of Making

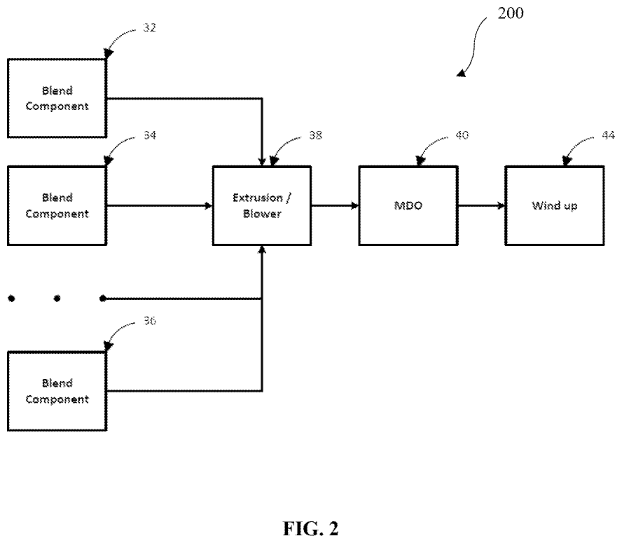

FIG. 2 shows an exemplary process 200 for producing an exemplary film in accordance with some embodiments of the present disclosure. The multilayer film 100 of the present invention may be produced by various methods used in producing multilayer films, including coextrusion and extrusion techniques. For example, the film 100 may be formed by coextrusion and blown to form a bubble. Blend components 32-36 may be melted and plasticized to form individual layers. Streams of individual layer materials may be fed into a coextrusion die, and while in the die, the layers may be combined in a desired arrangement, after which they emerge from the die in a single multilayer film of polymeric material.

As an example of the techniques that may be used to produce film, conventional methods may be suitable and may be useful in producing the film 100 such as by coextrusion techniques and lamination techniques. Coextrusion techniques include methods which include the use of a feed block with a standard die, a multi-manifold die such as a circular die for blown bubble film, as well as a multi-manifold die such as used in forming multilayer films for forming flat cast films and cast sheets. One particular advantage of coextruded films is in the formation of a multilayer film in one process step by combining molten layers of each of the film layers into a unitary film structure.

To produce a multilayer film by a coextrusion process, it is necessary that the constituents used to form each of the individual films be compatible, for example, have sufficiently similar melt properties, in the film extrusion process. In the practice of the present invention, the melt properties which are useful in determining compatibility may be determined, and once polymers having desirable physical properties are selected, experimental trials may be conducted in order to determine the optimal combination of relative properties in adjacent layers.

The multilayer films of the present invention can also be produced by a lamination technique. Lamination techniques are well known in the art. Such lamination techniques involve forming a multilayer film structure from prefabricated film plies. The basic methods used in film laminating techniques are fusion, wet combining, and heat reactivation. Fusion is a method of laminating two or more film plies using heat and pressure without the use of adhesives. This method can only be used where the films being laminated are comprised of polymers that readily form interfacial adhesion. Wet combining and heat reactivation are utilized in laminating incompatible films using adhesive materials.

Blend components 32-36 may represent one or more constituent substances of a composition used to make the film 100. Example blend components 32-36 include any of the thermoplastic polymer resins described above, the anti-stick additive described above, and/or other substances that may be received for heating and extrusion. Although a particular number of blend components 32-36 are shown in FIG. 2, the foregoing is not limiting, and in some embodiments, various numbers of substances may be introduced for film production purposes based on substances present in a desired film. Example quantities of blend components for producing a film 3 include about 1 to about 10, for instance, about 3 to about 6.

The blend components 32-36 may begin film production processing in various forms, such as solid rods, pellets, sheet, chunks, or otherwise. The blend components 32-36 may be held in various containers, such as hoppers, vats, etc., and may be dosed or fed to extrusion/blower section 38 for melting, extrusion, and blowing of the extruded blend into a bubble. A rate at which material from each of the blend component storage containers may vary, and may be based on various factors, such as a desired material extrusion rate or similar.

Coextrusion of the film 100 may be conducted at temperatures of from about 400° F. to about 510° F., although various other temperatures and ranges are possible based on melting points of the respective blend components 32-36. Coextrusion techniques may include the use of a feed block with a standard die, a multi-manifold die, such as a circular die, as well as a multi-manifold die such as used in forming flat cast films and cast sheets. Other techniques for extrusion may be possible in other embodiments.

In some embodiments, the film 100 may be made by blown film coextrusion. Blend components 32-36 may be fed to the extrusion and blowing portion 38 for coextrusion and blowing of the film into a bubble or sheath. In the extrusion and blowing portion 38, the blend components 32-36 are combined using extruders for mixing, melting, measuring, and preparing the film for further extrusion as a layer of film 100. As an example, the blends of each of the layers 5, 7, and 9 may be mixed and extruded in a similar manner to form the respective layers 5, 7, and 9. The extrusion can be performed using various techniques, such as a die. This may be repeated for additional layers of the film 100, until extrusion of each of the desired layers of the film 100 has completed.

After extrusion, the film 100 is further formed using a blown film apparatus. The apparatus may comprise a multi-manifold circular die head having concentric circular orifices. As part of an extension/blowing process 38 in accordance with some embodiments of the present disclosure, the film 100 may be blown out of the die as molten plastic, quenched by air to a solid state, and cooled to room temperature.

As an example, a first layer of film 100 may be extruded while in a melted state through a circular die of the apparatus. Each consecutive layer of film 100 may be subsequently extruded in a desired arrangement, such as on either side of the first layer (e.g., by selecting one or more additional circular dies concentric with a first circular die). Next, a gas, typically air, is blown through a central portion of the circular die head and into an interior portion of the extruded film 100 to form a bubble. In this regard, the bubble may expand individual layers of film 100.

Thereafter, the bubble may be collapsed onto itself (e.g., using a roller or other component of the blown film process) to form a substantially flattened sheath. The portions of the flattened sheath may be cut along opposing edges to form a pair of multilayer films. Usually, the pair of attached multilayer films are then cut apart at one or more of the edges and separated into a pair of multilayer films that can be spooled or wound onto a roll.

After the film 100 is blown and cut, it may pass downstream to one or more machine direction orientation (MDO) sections as part of MDO process 40. Sections of the MDO process 40 may stretch the film in the machine direction while still avoiding significant MD orientation. A stretching section of MDO process 40 may include heated rollers, followed by one or more stretching rollers and/or one or more cooling rollers. Heated rollers may heat film 100 to a desired temperature that is sufficient to allow stretching of the film but is below a melt temperature. In some embodiments, a temperature at which the film may be heated may be from about 50° C. to about 90° C., alternatively from about 40° C. to about 100° C. Quantities and arrangements of heated rollers and chilled rollers MDO process 40 may vary, and MDO process 40 may comprise one or more additional sets of stretching rollers, heated rollers, cooling rollers or other components in order to achieve desired characteristics of film 100 (e.g., porosity, opacity). The stretching rollers, heated rollers, and cooling rollers of MDO process 40 may be arranged as desired within the MDO process 40 and can be arranged in various combinations and quantities to achieve desired MDO of the film 100. Downstream of the stretching section of MDO process 40, the film 100 may be annealed by an annealing section. In this section, the film 100 travels through consecutive cooled and heated rolls. This process may set mechanical properties of the film.

In some embodiments, rates of speed at which one or more rollers of the MDO process 40 are operating may progressively increase based on a position of the one or more rollers within the MDO process 40. As an example, a first roller may have a first rotational speed, ω₁ (e.g., rad/s) and first tangential speed, v₁ (e.g., m/s). A second roller further downstream in the MDO process 40 may have a second rotational speed, cot and second tangential speed, v₂. In some embodiments, the second rotational speed, cot and second tangential speed, v₂ may be greater than the first rotational speed, ω₁ and first tangential speed, v₁. Subsequent rollers within the stream of MDO process 40 may have a rotational speed and tangential speed that is greater than rotational speed, ω₂ and tangential speed, v₂.

Following the MDO process 40, the film 100 may be rolled, wound or spooled into rolls as part of wind up process 44 using one or more winding rollers. The wind-up process 44 may allow for film 100 at room temperature to be formed into rolls for transportation and storage. Other techniques for winding the film 100 may be used in other embodiments.

### EXAMPLES

### Example 1

An exemplary film produced in accordance with an embodiment of the present disclosure is shown in Table 1 below. The exemplary film of Table 1 has three layers: Layer A (layer 5), Layer B (layer 7), and Layer C (layer 9). Table 1 shows respectively, in columns from left to right: 1) Layer identifier; 2) presence of polymeric compositions in the film as a weight percentage of the film thickness; 3) individual resin types present in the film by layer; 4) presence of individual substances in thermoplastic polymeric compositions of the film as a weight percentage of the composition the layer; 5) supplier name by individual thermoplastic polymer; 6) substance type identifier; 7) slip agent (ppm); 8) antiblock agent (ppm); 9) Melt Index (g/10 min.); and 10) density (g/cm³).

Table 1 shows exemplary characteristics for a film in accordance with some embodiments of the present disclosure. The film of Table 1 was formed according to the method described with regard to FIG. 2.

TABLE 1

| Layer | % | Resin | % | Supplier | Type | Slip | AB | MI | Density |
|---|---|---|---|---|---|---|---|---|---|
| A | 25% | M6410 | 95.50 | Baystar | HDPE | 0 | 0 | 1.2 | 0.956 |
| | | 102109 | 2.00 | Ampacet | slip | 100,000 | 0 | 8 | 0.92 |
| | | BI-551 | 0.50 | Bayshore | AB | 0 | 500,000 | 8 | 1.14 |
| | | AMF-607 | 2.00 | Bayshore | PA | 0 | 0 | 8 | 0.93 |
| B | 50% | 7845 | 49.00 | Exxon | HDPE | 0 | 0 | 0.45 | 0.958 |
| | | SC 74858 | 48.00 | Westlake | LLDPE | 0 | 0 | 0.5 | 0.917 |
| | | 102109 | 2.00 | Ampacet | slip | 100,000 | 0 | 8 | 0.92 |
| | | AMF-607 | 1.00 | Bayshore | PA | 0 | 0 | 8 | 0.93 |
| C | 25% | M6410 | 95.50 | Baystar | HDPE | 0 | 0 | 1.2 | 0.956 |
| | | 102109 | 2.00 | Ampacet | slip | 100,000 | 0 | 8 | 0.92 |
| | | BI-551 | 0.50 | Bayshore | AB | 0 | 500,000 | 8 | 1.14 |
| | | AMF-607 | 2.00 | Bayshore | PA | 0 | 0 | 8 | 0.93 |

### Example 2

An exemplary film was produced in accordance with an embodiment of the present disclosure. A comparative film formed of PET was also produced. The exemplary film and the comparative PET film were tested for physical and mechanical properties. The results of the testing are shown in Table 2 below.

As can be seen in Table 2, the exemplary film demonstrated superior mechanical properties, including tensile strength, Elmendorf tear strength, and elongation, when compared to the comparative PET film.

TABLE 2

| | | | Exemplary Film | | Comparative PET Film | |
|---|---|---|---|---|---|---|
| Property | ASTM | Units | Average | St. Dev | Average | St. Dev |
| Thickness | In-house | mil | 1.25 | 0.09 | 0.63 | 0.05 |
| Ultimate Tensile- MD | D-882 | lbf/(in\hat{ }2) | 18058 | 920 | 12814 | 301 |
| Ultimate Tensile- TD | D-882 | lbf/(in\hat{ }2) | 3896 | 425 | 17371 | 3664 |
| Tensile Yield- MD | D-882 | lbf/(in\hat{ }2) | 17936 | 949 | 12814 | 301 |
| Tensile Yield- TD | D-882 | lbf/(in\hat{ }2) | 3896 | 425 | 11878 | 684 |
| Elongation % - MD | D-882 | % | 160 | 12 | 13.4 | 0.5 |
| Elongation % - TD | D-882 | % | 15 | 8 | 50.2 | 34.8 |
| 1% Secant Modulus - MD | D-882 | lbf/(in\hat{ }2) | 221709 | 18200 | 484972 | 78000 |
| 1% Secant Modulus - TD | D-882 | lbf/(in\hat{ }2) | 218865 | 6370 | 523715 | 34200 |
| Slow Puncture- Max Force | F-1306 | lbf | 1.13 | 0.109 | 4.1 | 0.165 |
| Slow Puncture- Distance | F-1306 | in | 0.237 | 0.017 | 0.28 | 0.0064 |
| Slow Puncture- Energy | F-1306 | lbf [symbol] in | 0.093 | 0.013 | 0.391 | 0.031 |
| Gurley Stiffness - MD | D-6125 | Gurley Units | 32.81 | 5.68 | 10.66 | 1.42 |
| Gurley Stiffness - TD | D-6125 | Gurley Units | 16.68 | 3.31 | 9.84 | 0 |
| Static COF | D-1894 | — | 0.37 | 0.015 | 0.46 | 0.03 |
| Kinetic COF | D-1894 | — | 0.35 | 0.01 | 0.39 | 0.012 |
| Opacity | 550 nm | 100-% T at 550 nm | 37.9 | 0.405 | 19.68 | 0.102 |
| % Transmittance | 750 nm | % | 70.17 | 0.66 | 83.28 | 2.22 |
| Gloss - 45 deg top | D-2457 | — | 55.6 | 3.6 | 175.6 | 1.4 |
| 1600 gfc Elmendorf Tearing - MD | D-1922 | gms | 26 | 10 | 4 | 0 |
| 1600 gfc Elmendorf Tearing - TD | D-1922 | gms | 797 | 338 | 11 | 2 |

[symbol]

indicates data missing or illegible when filed

### Example 3

An exemplary film was produced in accordance with an embodiment of the present disclosure. Comparative films 1, 2, 3, and 4 were also produced. The properties of each of the films are shown in Table 3 below. The exemplary film and the comparative films were tested for physical and mechanical properties. The results of the testing are also shown in Table 3 below.

As can be seen from Table 3, the exemplary film demonstrated excellent seal strength and excellent oxygen and moisture barrier properties when compared to comparative films 1, 2, 3, and 4.

TABLE 3

| | | Exemplary | Comparative | Comparative | Comparative | Comparative |
|---|---|---|---|---|---|---|
| | (units) | Film | Film 1 | Film 2 | Film 3 | Film 4 |
| Test | | | | | | |
| DSC Melting Points | (° C.) | 10 [symbol] (LDPE) | 1 [symbol] 0 (LDPE) | 102 (LDPE) | 103 (LDPE) | 97 (EVA [symbol] 10% |
| | | 130 (HDPE) | 118 (mLLDPE) | 126 (LLDPE) | 121 (LLDPE) | VA Content) |
| | | | 235 (PET) | 216, 234 (PET) | 1 [symbol] (PP | 105 (LDPE) |
| | | | | | Homopolymer) | 126 (LLDPE) |
| | | | | | | 218, 236 (PET) |
| FT-IR Transmission Scan | | PE, TiO2 | PET, PE, TiO2 | PET, PE, TiO2 | PP, PE, TiO2, | PET, PE, TiO2 |
| | | | | | trace Urethane | |
| ATR-IR Surface Scan, outside | | PE, Slip | PET | PET | PP | PET |
| ATR-IR Surface Scan, inside | | PE | PE with slight | PE, Slip | PE with slight | PE, EVA Blend |
| | | | oxidation | | oxidation | |
| OTR @ 23°, 0% RH | (cc/100 in²/day) | 7.51 | 6.63 | 7.57 | 68.47 | 7.00 |
| WVTR, 37.8° C., 100% RH | (g/100 in²/day) | 0.208 | 0.322 | 0.384 | 0.276 | 0.580 |
| Heat Seal Curve, 60 psi, | | | | | | |
| 1 sec dwell. Peel Force | | | | | | |
| at T(° C.) = | | | | | | |
| 95 | (lbf) | 0.31 | 0.02 | 0.11 | 0.05 | 0.05 |
| 100 | (lbf) | 0.78 | 0.01 | 0.22 | 0.45 | 0.73 |
| 105 | (lbf) | 2.32 | 0.74 | 0.87 | 2.27 | 3.24 |
| 110 | (lbf) | 4.40 | 2.24 | 3.17 | 9.90 | 7.41 |
| 115 | (lbf) | 5.25 | 10.00 | 4.97 | 16.28 | [symbol] .29 |
| 120 | (lbf) | 10.10 | [symbol] . [symbol] 7 | 10.24 | 16.00 | [symbol] .15 |
| 125 | (lbf) | 1 [symbol] . [symbol] 8 | 12. [symbol] 4 | 12.6 [symbol] | 16.93 | 8. [symbol] 9 |
| 130 | (lbf) | 1 [symbol] .9 [symbol] | 1 [symbol] . [symbol] | 10.66 | 12.44 | [symbol] .04 |
| 135 | (lbf) | 1 [symbol] .65 | 14.63 | 11. [symbol] 7 | 15.0 [symbol] | 9.3 [symbol] |
| 140 | (lbf) | 1 [symbol] .10 | 14. [symbol] 4 | 12.30 | 15.26 | 9.37 |
| 145 | (lbf) | 12.5 [symbol] | 12. [symbol] | 13.40 | 19.32 | [symbol] .9 [symbol] |
| 150 | (lbf) | 1 [symbol] .14 | 14.41 | 12.97 | 14.0 [symbol] | 10.54 |
| Seal Initiation Temp @ | (° C.) | 95 | 102 | 100.6 | 98.1 | 96.8 |
| 0.3 lbf | | | | | | |

[symbol]

indicates data missing or illegible when filed

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The foregoing description illustrates and describes the processes, machines, manufactures, compositions of matter, and other teachings of the present disclosure. Additionally, the disclosure shows and describes only certain embodiments of the processes, machines, manufactures, compositions of matter, and other teachings disclosed, but, as mentioned above, it is to be understood that the teachings of the present disclosure are capable of use in various other combinations, modifications, and environments and is capable of changes or modifications within the scope of the teachings as expressed herein, commensurate with the skill and/or knowledge of a person having ordinary skill in the relevant art. The embodiments described hereinabove are further intended to explain certain best modes known of practicing the processes, machines, manufactures, compositions of matter, and other teachings of the present disclosure and to enable others skilled in the art to utilize the teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein. Any section headings herein are provided only for consistency with the suggestions of 37 C.F.R. § 1.77 or otherwise to provide organizational queues. These headings shall not limit or characterize the invention(s) set forth herein.

What is claimed is:

1. A recyclable film having at least one layer, the layer comprising:
a blend of a first thermoplastic polymer and a second thermoplastic polymer, wherein each of the first thermoplastic polymer and the second thermoplastic polymer has a melt index of about 0.5 g/10 min. or less, and
an anti-stick additive comprising an amide compound having a melting point of at least about 115° C.

2. The recyclable film of claim 1, wherein the first thermoplastic polymer and the second thermoplastic polymer are each selected from the group consisting of linear low-density polyethylene (LLDPE), super hexene linear low-density polyethylene (super hexene LLDPE), bimodal metallocene linear low-density polyethylene (mLLDPE), low-density polyethylene (LDPE), high-density polyethylene (HDPE), bimodal high-density polyethylene (bimodal HDPE), and combinations of the foregoing.

3. The recyclable film of claim 1, wherein the first thermoplastic polymer is linear low-density polyethylene (LLDPE), super hexene linear low-density polyethylene (super hexene LLDPE), bimodal metallocene linear low-density polyethylene (mLLDPE), or a combination of the foregoing.

4. The recyclable film of claim 1, wherein the first thermoplastic polymer has a melt index of about 0.5 g/10 min.

5. The recyclable film of claim 1, wherein the second thermoplastic polymer is high-density polyethylene (HDPE), bimodal high-density polyethylene (bimodal HDPE), or a combination of the foregoing.

6. The recyclable film of claim 1, wherein the second thermoplastic polymer has a melt index of about 0.45 g/10 min.

7. The recyclable film of claim 1, wherein the first thermoplastic polymer and the second thermoplastic polymer are present in the blend in a ratio of about 50:50.

8. The recyclable film of claim 1, wherein the anti-stick additive is a bisamide.

9. The recyclable film of claim 1, wherein the anti-stick additive is ethylene bis(oleamide).

10. The recyclable film of claim 1 wherein the anti-stick additive is present in the layer in an amount of about 3% by weight or less.

11. A recyclable multi-layer film, comprising:
an outer layer, an inner layer, and an intermediate layer disposed between the outer layer and the inner layer,
wherein the intermediate layer comprises a blend of a first thermoplastic polymer selected from the group consisting of LLDPE, super hexene LLDPE, mLLDPE, and combinations thereof, and a second thermoplastic polymer selected from the group consisting of HDPE, bimodal HDPE, and combinations thereof, wherein each of the first thermoplastic polymer and the second thermoplastic polymer has a melt index of about 0.5 g/10 min. or less, and
wherein the outer layer, the inner layer, and the intermediate layer each comprise an anti-stick additive, wherein the anti-stick additive comprises a bisamide having a melting point of at least about 115° C.

12. The recyclable multi-layer film of claim 11, wherein the anti-stick additive is present in each of the outer layer, the inner layer, and the intermediate layer in an amount of about 4% by weight or less.

13. The recyclable multi-layer film of claim 11, wherein the anti-stick additive is ethylene bis(oleamide).

14. The recyclable multi-layer film of claim 11, wherein the anti-stick additive has a melting point of at least about 125° C.

15. The recyclable multi-layer film of claim 11, wherein the first thermoplastic polymer is super hexene LLDPE and the second thermoplastic polymer is bimodal HDPE.

16. A packaging container formed of a recyclable multi-layer film, the recyclable multi-layer film comprising:
at least one layer comprising:
a blend of a first thermoplastic polymer selected from the group consisting of LLDPE, super hexene LLDPE, mLLDPE, or a combination of the foregoing, and a second thermoplastic polymer selected from the group consisting of HDPE, bimodal HDPE, or a combination of the foregoing, wherein each of the first thermoplastic polymer and the second thermoplastic polymer has a melt index of about 0.5 g/10 min. or less, and
an anti-stick additive, wherein the anti-stick additive comprises a bisamide having a melting point of at least about 120° C.

17. The packaging container of claim 16, wherein the bisamide is ethylene bis(oleamide).

18. The packaging container of claim 16, wherein the anti-stick additive is present in the layer in an amount of about 3% by weight or less.

19. The packaging container of claim 16, wherein the first thermoplastic polymer is super hexene LLDPE and the second thermoplastic polymer is bimodal HDPE.

20. The packaging container of claim 16, having a water vapor transmission rate of less than about 0.250 g/100 in²/day.
